(19) United States
(12) Patent Application Publication
(10) Pub. No.: US 2006/0058023 A1
(43) Pub. Date: Mar. 16, 2006

(54) Educational Satellite system and a method of use thereof

(76) Inventors: James J. White, Parker, CO (US); Timothy L. White, Denver, CO (US); David J. Barnhart, USAF Academy, CO (US); John B. Clark, Colorado Springs, CO (US); Jerry Jon Sellers, Manitou Springs, CO (US); Carl Lon Enloe, Colorado Springs, CO (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/940,899

(22) Filed: Sep. 14, 2004

(51) Int. Cl. H04Q 7/20

(52) U.S. Cl. 455/427

(57) ABSTRACT

In one embodiment, an educational non-flight capable satellite is described comprising a plurality of modular subsystems that are adapted to be coupled together via standardized bus connectors and standard mechanical connectors. The educational satellite is fully functional and can be utilized for teaching satellite engineering and operation at high school through college level courses.

### FIELD OF THE INVENTION

This invention generally relates to satellites and space engineering. More particularly, this invention pertains to a modular mock fully functional satellite and methods of using the satellite in teaching satellite construction and operation.

### BACKGROUND

The study of satellite engineering at most colleges and universities is primarily book-based. Flight capable satellites are just too expensive to purchase enough units for hands-on laboratory use for more than a handful of students. Further even if cost were not a consideration, complete off the shelf prior satellites do not exist around which a standardized high school or undergraduate level course can be built.

The subsystems of a typical satellite include: (1) a power subsystem for powering the satellite's other subsystems; (2) a communications subsystem for transmitting and receiving information, commands and data from a ground station, (3) an attitude control subsystem for positioning the satellite, (4) experiment/payload subsystems for performing certain tasks and experiments and generating data relating to the task or experiments; (5) a data handling and central control subsystem for integrating the other subsystems to facilitate inter-subsystem cooperation in performing certain tasks; and (6) a structural subsystem in which the other subsystems are contained. Other subsystems are possible as well depending on the particular intended functionality of the satellite.

In most college and university classes that include laboratory teaching portions, hands-on learning typically involves using non-integratable satellite subsystems or mock subsystems designed to operate in a similar manner as actual subsystems to perform simulated characterization, operation, quality control, and/or acceptance testing. However, since these subsystems cannot be integrated, the educational value of experiencing how the various systems work together in a complete satellite is negligible.

In 1999, Stanford University and the California Polytechnic State University of San Luis Obispo agreed to collaborate on the development of a standard for micro-satellites so small research satellites could be economically produced and, more significantly, deployed by universities and colleges. The resulting Cubesat™ standard specifies a flight capable cube-shaped satellite that is 10 cm on a side and weighs no more than 1 kg. Additionally, the Cubesat™ specification requires a standard electronic interface with the deployer. However, concerning the internal electronics, no standards are provided. From the standpoint of a flight capable satellite, not providing a standard for the internal electronics makes sense as those designing a satellite to perform a particular task that has to meet a firm mass and volumetric requirement do not want to be saddled with using potentially redundant components to satisfy a specification if those components are not used for their application.

The standardization helps reduce the cost of launching a Cubesat™ but it does not necessarily reduce the cost of fabricating the satellite itself. Because of the cost of putting together a Cubesat™, very few universities or colleges endeavor in fabricating one. Even those universities and colleges that are or have produced a Cubesat™, they have not done so in furtherance of an undergrad level course. Further, even if the cost were not prohibitive, it is unlikely that a Cubesat™ could be designed and fabricated within the length of a typical college course or even an entire college year. Typically, Cubesats™ are fabricated by a small select number of graduate level students and although undergraduate students and even graduate students outside of the select few may be able to view the satellite, they are not able to handle or perform experiments on it.

### SUMMARY OF THE DRAWINGS

FIG. 1 is an isometric view of an integrated satellite system suspended from a stand according to one embodiment of the present invention.

FIG. 2 is another isometric view of an integrated satellite system suspended from a stand according to one embodiment of the present invention.

FIG. 3 is an isometric view of an integrated satellite stack according to one embodiment of the present invention.

FIG. 4 is a block diagram of the various subsystems of the satellite system according to one embodiment of the present invention.

FIG. 5 is a block diagram representation of the power subsystem according to one embodiment of the present invention.

FIG. 6 is a block diagram representation of the data control and handling subsystem according to one embodiment of the present invention.

FIG. 7 is a block diagram representation of the communications subsystem according to one embodiment of the present invention.

FIG. 8 is a block diagram representation of the attitude control subsystem according to one embodiment of the present invention.

FIG. 9 is an isometric view of the satellite housing according to one embodiment of the present invention.

FIG. 10 is a pin assignment chart for the bus connectors according to one embodiment of the present invention.

FIG. 11 is a flow chart indicating a methodology for teaching satellite engineering using an educational satellite system according to one embodiment of the present invention.

### DETAILED DESCRIPTION

One embodiment of the current invention comprises an educational satellite system including a combination of electronic subsystems, such as a power subsystem, a communications subsystem, a central data handling subsystem and an attitude control subsystem, that are integratable by way of a standard bus. Each subsystem can not only be inspected and characterized by itself but also in conjunction with one or more of the other subsystems.

Preferably in the one embodiment, each subsystem comprises a separate module that is connectable to each other module either or both of mechanically through one or more connectors and electrically through pin and socket bus connectors. In preferred variations, the subsystems are integrated on a single circuit board (or in the case of the power and attitude control subsystems on two nested boards) that include snap connectors located on the each board's corners to join and coupled with corresponding connectors on adjacent boards. Further, in the preferred variations (although not all variations), the pin and socket connectors are PC-104 pin and socket bus connectors, although the pins are not configured to operate using the PC 104 standard for reasons that will become apparent below. Accordingly, a student (or other user) can quickly and easily couple the modules together without having to build a coupling structure or string numerous jumper wires between the boards.

The standard mechanical and electrical connections and configurations of the various subsystem modules facilitates expansion of the satellite system using other subsystems, such as those designed to perform certain experiments or tasks, providing they conform to the dimensional requirements of the satellite system and utilize similarly configured bus and operational protocols. Accordingly, the one embodiment educational satellite system can be used as a standard platform for students or other users to design, build and test new subsystem modules.

In embodiments of the present invention, the satellite system is not designed and configured for actual space flight but rather includes most of or essentially all of the functionality of a flight qualified satellite. Off the shelf commercial circuits, circuit boards, sensors and other components can be used in the subsystems and the entire satellite system, thereby substantially reducing the cost of the satellite when compared to flight qualified satellites, such as those based on the Cubesat™ standard, which must utilize much more expensive space qualified components.

The relatively low cost, the ease of assembly and disassembly, and the integration of a set of subsystem modules make embodiments of the present invention suitable for hands on educational use by students learning the basics of satellite engineering. The ability to actually integrate a substantially functional satellite (except for space readiness) further reinforces lessons learned in lectures and from text books or other written materials. Accordingly, another embodiment of the present invention describes a methodology of teaching satellite engineering using a modular satellite system of the type described herein. The method and its variations comprise teaching a number of aspects related to satellite including, but not limited to: design, engineering, assembly, integration, test, and operation. Further, because of the ability to add new subsystem modules to the satellite system, the satellite system can also be used in advanced engineering and graduate level classes to test student-designed and fabricated subsystems.

An exemplary lab manual and student workbook are included as Appendices A and B of this specification that relate to an undergraduate level laboratory course wherein small groups of students work together as satellite integrators to (i) perform acceptance testing on each subsystem validating and characterizing its performance relative to design specifications, (ii) integrate the subsystem into previously accepted subsystems, and (iii) perform testing on the integrated satellite.

The advantages of the embodiments described herein above and below along with the particular configuration of the described embodiment(s) of the invention are not conclusive or even exhaustive but rather merely representative of the best mode of using the invention. Rather, numerous variations and other embodiments have been contemplated that read on the appended claims and are, accordingly, intended to be within the scope of the invention. For example, the laboratory course provided for in the laboratory manual and the workbook of the appendices is merely exemplary and is not to be construed as in any way limiting how embodiments of the satellite system can be used as an educational tool.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact. For example, two electronic components are electrically coupled if current can flow from one component to the other either directly or indirectly through intervening components.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The term “satellite” as used herein refers to any device designed either to be placed in planetary orbit or any non-flight capable device designed to simulate a flight-capable satellite.

The terms “bus” as used herein refers to any standard assembly of conductors for passing current and signals along a common paths among several devices, components, modules, circuit boards, etc.

The phrase “bus connector” as used herein refers to any standard assembly of one or more electrical connectors for coupling two or more devices, components, circuit boards and/or modules to a common bus.

The term “module” as used herein typically refers to a single subsystem that can be coupled to other subsystem modules one or both of mechanically or electronically to form a satellite. Modules may, although not necessarily, be capable of independent operation without or without being integrated with the other modules of the satellite. A module may comprise a single circuit board or several boards, as well as, one or more peripherals that can be connected or coupled to the boards. The modules, in variations and other embodiments, need not follow the form factor described and illustrated herein.

The phrase “non-flight capable” as used herein to refer to a satellite or an educational satellite refers to any satellite that comprises at least one or more components that (i) are not space flight qualified or (ii) do not meet specifications necessary for the component to be space-qualified. Specifications and certifications concerning the space qualification of a satellite and/or its components are based on industry recognized standards.

One Embodiment of an Educational Satellite System

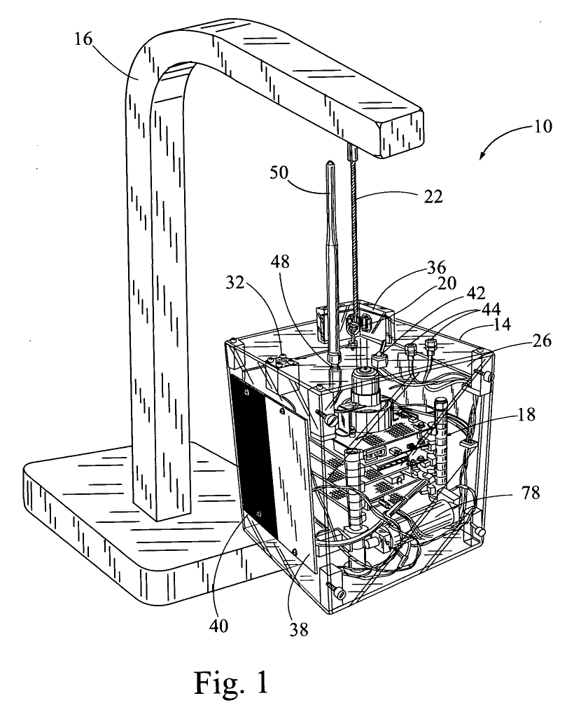

One embodiment of an integrated educational satellite system 10 is illustrated in FIGS. 1-3. Referring primarily to FIGS. 1 & 2, the satellite system is shown integrated into its structural housing 14 and suspended from the boom of a stand 16. The satellite typically comprises (i) a stack 18 of subsystem modules that are both mechanically and electronically coupled together, (ii) the housing 14 that is preferably at least partially translucent for containing the satellite and provides a hanging means, such as an eyelet 20, for hanging the satellite, and (iii) a number of sensors, actuators and other devices used to among other things gather environmental data and vary the positioning (or attitude) of the satellite as desired.

The Satellite Housing

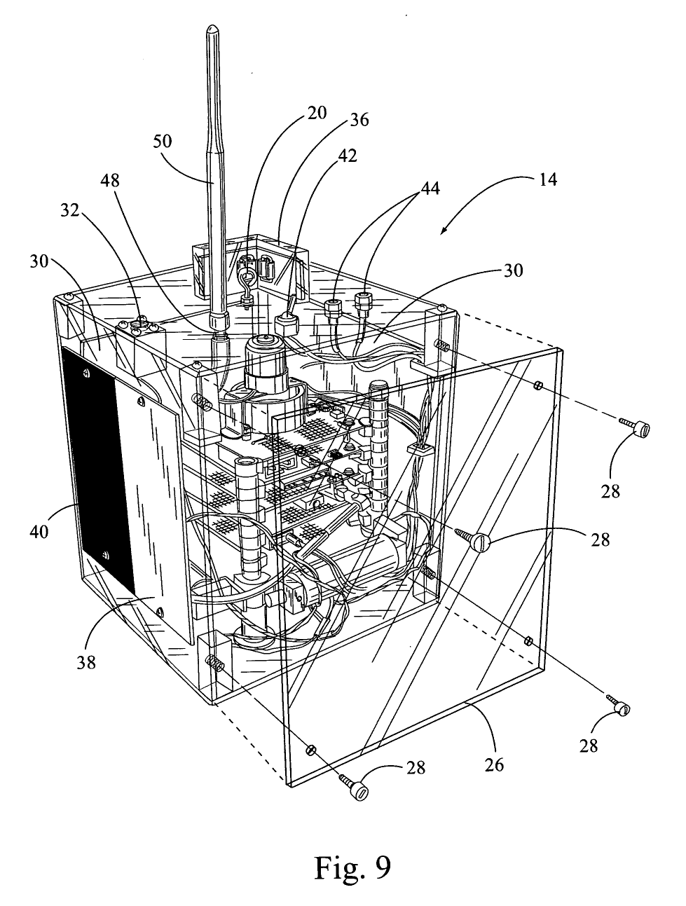

The housing 14, as illustrated in FIGS. 1 & 2 and alone in FIG. 9, typically comprises an orthogonal box of a translucent material, such as polycarbonate, which permits a student to view the satellite's internal electronics while operating the satellite. The eyelet 20 is provided on the center of the top side of the housing from which the satellite can be hung from the illustrated stand 16, or, more commonly a ceiling using a suitable cable 22. Accordingly, the satellite is free to pivot about its generally vertical center axis at the eyelet to change its attitude. The cable or the eyelet can include a freely pivoting coupling (not shown) to help ensure free pivotal movement of the satellite 10. As illustrated, the sides of the housing are fastened together with screws 24; however, the sides can be joined by any suitable means including adhesive bonding. At least one side 26 is configured to provide a student with access to the interior of the housing allowing insertion and removal of the satellite stack 18. As illustrated, the removable side includes four thumb screws 28, although in other variations other removable attachment means can be used, such as clasps, clamps, bolts, and slots.

A number of devices are attached to the housing, each of which will be described in greater detail below, including two solar panels 30 that are attached to orthogonal generally vertical sides of the housing 14. Top and bottom sun sensors 32 &34 are secured to the inside of the respective top and bottom sides of the housing with openings provided for the sensors through the sides. A set of orthogonally facing yaw sensors 36 that comprises small solar panels are also mounted to the top side of the housing. Further, on another generally vertical side of the housing, adjacent white and black thermal panels 38 & 40 are provided that include thermistors mounted to the back sides of the panels. A power on and off switch 42 is mounted on the top side of the satellite as are jacks 44 for receiving positive and negative leads from an external power supply to recharge the satellites batteries or power the satellite externally. Finally, an opening 46 is provided on the top side of the housing through which a connector 48 for attaching an antenna 50 is received.

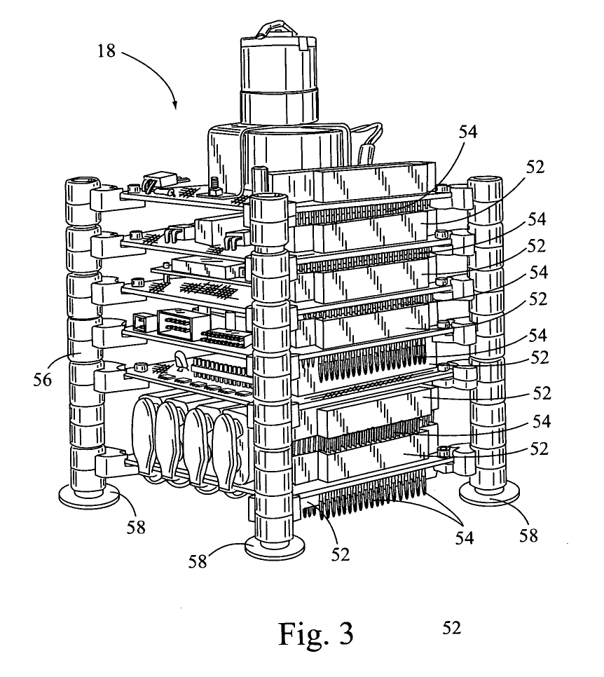

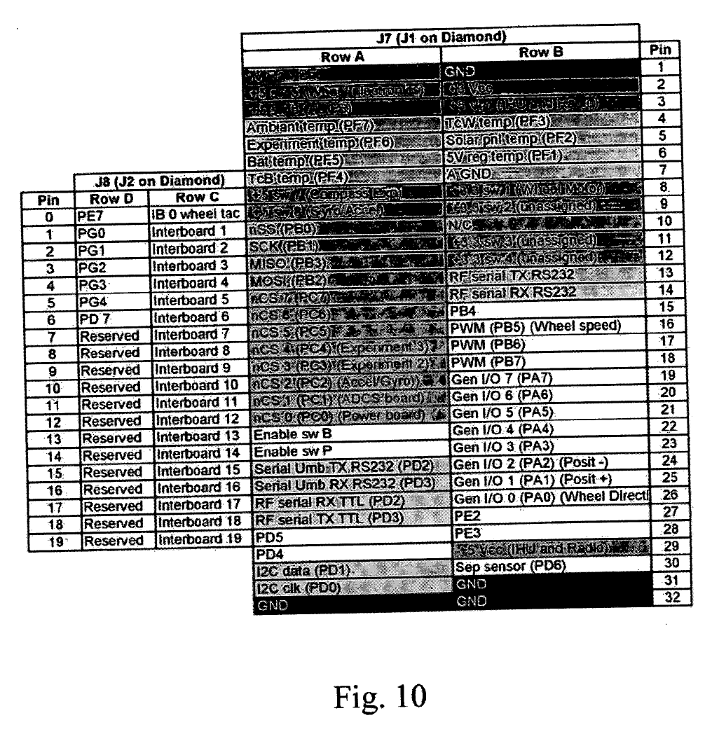

A typical stack 18 of integrated subsystem modules is illustrated in FIG. 3. In the illustrated embodiment, each subsystem comprises one or more circuit boards having the PC 104 form factor including PC104 bus connectors 52 on the top side of each board and corresponding pins 54. The PC104 connectors in the illustrated embodiment do not utilize the PC104 standard pin assignments; however, variations using the PC104 pin assignments are contemplated as well. The actual pin assignments used to pass data and power between the various interconnected subsystems modules is illustrated in FIG. 10. The boards are stacked on top of one another and are mechanically connected using SnapStik™ connectors 56 by Parvus Corporation of Salt Lake City, Utah that are bolted to each corner of each circuit board. To more securely hold the stack together one or more SnapPosts™ (not shown) can be passed through the interior of an aligned column of SnapSticks™ and threaded into a SnapFlange™ 58 at the other end. Preferably, the SnapFlange™ is secured to a bottom side of the housing 14 to hold the stack in place within the housing. In other variations and embodiments, circuit boards having other form factors and other types of suitable mechanical connectors can be used in place of the boards and connectors illustrated and described herein as would be obvious to one of ordinary skill in the art with the benefit of this disclosure.

The Satellite Stack

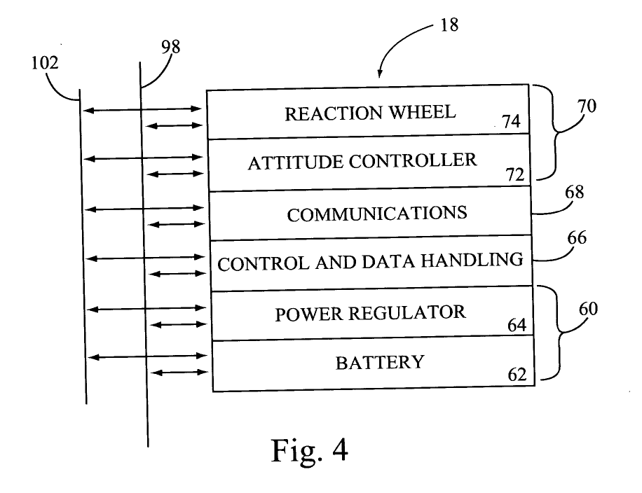

Referencing FIG. 4 in addition to FIG. 3, the subsystem modules comprising the satellite stack 18 starting from the bottom include (i) the power subsystem 60 comprising both a first circuit board 62 with a battery pack and a second circuit board 64 including several regulated power supplies, (ii) a central data handling subsystem 66 including thermal data acquisition functionality, (iii) a communications subsystem 68, and (iv) an attitude control subsystem 70 comprising a primary circuit board 72 and an optional secondary board 74 having a reaction wheel 76 mounted thereon. Each of the subsystems are operatively coupled through the bus connectors 52 joining each board in the stack along both power and data busses 98 & 100. The power bus 98 feeds regulated and unregulated voltage along specific sets of pins. Data from the various modules to and from one another and through the central data handling subsystem is transmitted over additional sets of pins comprising the data bus 100. Additional peripheral devices, such as but not limited to torque rods 78, solar panels 30, thermistors, and sun sensors 32 & 34 are coupled to the stack by way of various connectors provided on the applicable subsystem boards. Each of the subsystems is described in detail below.

The Power Subsystem

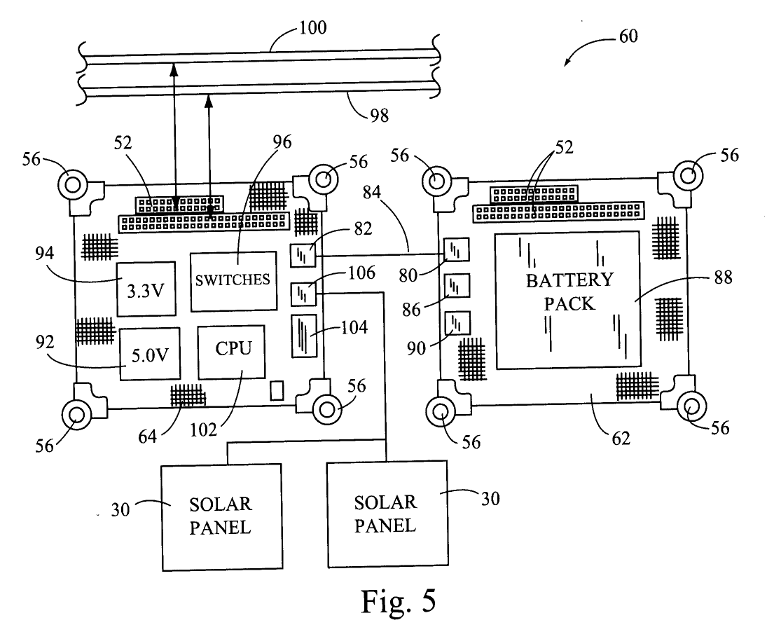

The power subsystem 60 is graphically represented in FIG. 5 and comprises two circuit boards 62 & 64 although in variations, the entire subsystem module can be contained on a single board. As illustrated, the first board 62 (also referred to herein as a battery board) comprises a 9v, 1600 mAH battery pack that is coupled with the second board 64 by way of respective power port output and input connectors 80 & 82 and a power harness 84 that spans the connectors. Also, provided on the battery board is a charge port connector 86 for connecting the battery pack 88 to an external power supply to charge it. Finally, a SEP switch connector 90 is provided. The SEP switch connector can be coupled to a switch (not shown) on the housing which is triggered when the satellite 10 is lifted off of a supporting surface to simulate separation of the satellite from a deployer of a launch vehicle during deployment. In embodiments of the educational satellite, the triggering of the SEP switch causes a message to be provided in the satellite telemetry. Although a complete PC104 connector 52 is provided on the battery board, only the ground pins, a temperature sensor (pin A6 in the EyaBUS™) and the SEP sensor pin (see FIG. 10) are connected.

In another variation of the power subsystem that is not illustrated, the battery pack is not contained on a separate circuit board but the batteries, which comprise AA cells instead of 9v cells, are mounted to the underside of the underside of a single power subsystem circuit board. Of course, any number of variations concerning the placement and configuration of one or more battery packs are contemplated.

The second board 64 of the power subsystem 60 (also referred to herein as the power regulator board) comprises both 5 volt and 3.3 volt regulated power supplies 92 & 94. Each power supply has one fixed non-switched line that is coupled directly to the bus connector 52 (pins 2 & 3 in row B as shown in FIG. 10). Further, the power regulator board 64 includes a switching circuit 96 that comprises a plurality of pFET transistors for switching four lines respectively from each power supply off and on. The lines from the switching circuit are coupled to the bus connector (pins 2, 3, 8 & 9 in row A, and pins 8, 9, 11 & 12 in row B). The aforementioned 3.3v and 5.0v lines along with an unregulated 9v line on pin 1 of row A comprise the satellite's power bus 98.

A CPU 102 is provided for controlling the operation of the power subsystem 60 independent of the central data handling subsystem 66. Particularly, the CPU controls the collection and transmission of telemetry information relating to the operation of the power subsystem, such as but not limited to voltage and current levels of the batteries, the solar array, and the regulated 3.3v and 5v lines. Telemetry information is available through a direct RS-232 connection 104 on the board or through the data bus 100 of the satellite 10 which is accessible via one or more pins of the bus connector 52. Advantageously, the operation of the power subsystem can be verified by coupling the board to a PC via the RS-232 serial connection without having to use either the communications subsystem 68 or the central data handling subsystem.

A solar panel connector 106 is provided on the power regulator board 64 to which one or more solar arrays can be attached. In the illustrated embodiment, the two solar panels 30 mounted to the housing comprise the solar array and are capable of outputting up to 18v and 120 mA in full sun. The power from the panels further assists in the operation of the satellite by augmenting the battery pack 88. In the described embodiment, the solar array does not generate enough power to run the satellite sans the batteries and is provided primarily for educational purposes. In contrast in a flight capable satellite, the solar panels would be of sufficient size to facilitate their use as the primary power source with the batteries serving only a backup function. Of course, larger or more efficient solar panels can be used in variations and alternative embodiments that do output enough current to serve as the satellites primary power source.

The battery input connector 82 described above is typically connected by way of the power harness 84 to the battery board 62; however, the input connector can also be used to connect an external power supply by way of the positive and negative power jacks 44 on the satellite housing 14 and a cable spanning therebetween. A battery enable connector 108 is also provided. The battery enable connector comprises two pins that must be conductively coupled in order for power to flow from the battery board. A jumper wire can be used to bridge the connector or when the stack 18 is contained in the housing the connector can be coupled to the power on and off switch 42 that is located on the top of the housing.

The Central Data Handling Subsystem

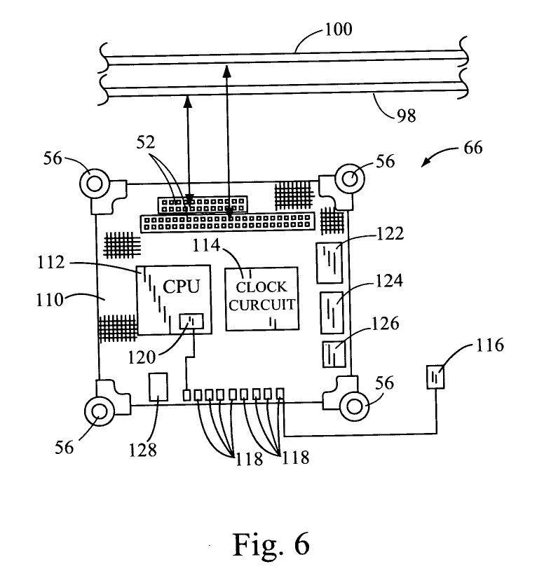

The central data handling subsystem 66 is graphically represented in FIG. 6. The central data handling subsystem comprises a CPU 112, a clock circuit 114, thermal data acquisition capability and a number of connectors related to the subsystem's functionality all located on a single circuit board 110.

The single circuit board 110 includes the standard bus connector 52 and pins for interfacing with the connector and pins of other subsystem boards. As with all other subsystems and circuit boards the specific pins of each connector are similarly assigned as other sets of pins of the other connectors of the satellite stack 18. The pins across which power is transmitted comprise the power bus 98 and the pins across which analog or digital data is transmitted comprise the data bus 100. Numerous pins of the bus connector are predefined relative to which subsystem they are configured to transmit data and commands to and from. Additionally, a number of the pins are unassigned and can be utilized to transmit data and commands relative to future experimental or operational subsystems that may be integrated into the stack.

Operationally, the central data handling subsystem 66 collects telemetry data across the data bus 100 from all the subsystems in the stack 18. Further, the central data handling subsystem receives commands sent to it by way of the communications subsystem 68 and transmits them to the appropriate subsystem for processing. The clock circuit 114 provides data to the CPU to time stamp the telemetry, as well as, provide for telemetry acquisition at specific time intervals.

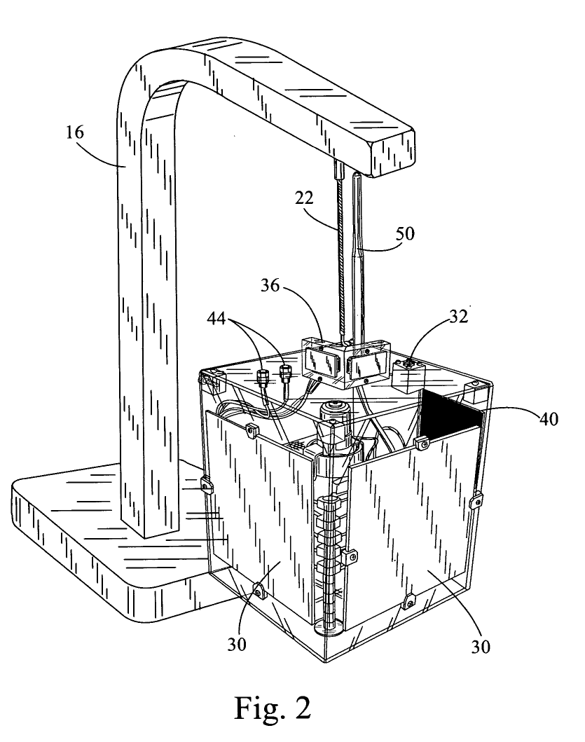

The central data handling subsystem 66 also includes a thermal data acquisition capability in which the temperatures of up to eight thermistors 116 connected to eight provided analog input connectors 118 can be read and reported via telemetry. The acquisition and reporting of thermistor temperature data is controlled by the CPU 112. In the illustrated embodiment, another thermistor 120 is connected to the CPU to monitor its temperature. Referring to FIG. 2, one thermistor is attached to the backside of the white thermal panel 38 and another is attached to the backside of the black thermal panel 40. Both of these thermistors including up to six others are coupled to the input connectors on the central data handling subsystem to provide a comprehensive picture of the thermal conditions of the satellite 10 during operation.

The connectors provided on the central data handling subsystem in addition to the bus connector 52 and the analog input connectors 118 include several RS-232 connectors: an ISP connector 122 for programming or updating the CPU's firmware; a general RS-232 umbilical connector 124 for directly testing and controlling the operation of the central data handling subsystem; and an RF connector 126 for emulating data that is sent to and transmitted wirelessly by the communications subsystem 68. Normally, the RS-232 ports are only used during the testing, calibration and setup of the central data handling subsystem 66 and the stack 18. Once the stack is fully integrated, all communication between the satellite and a ground station computer occurs wirelessly based on commands and data routed by the central data handling subsystem to and from the communications subsystem 68 and the other subsystems.

A power port connector 128 is also provided on the board 110 wherein the board can be connected to a regulated power supply, so that the subsystem 66 can be tested and configured without having to integrate it with the stack 18 and the power subsystem 60.

The Communications Subsystem

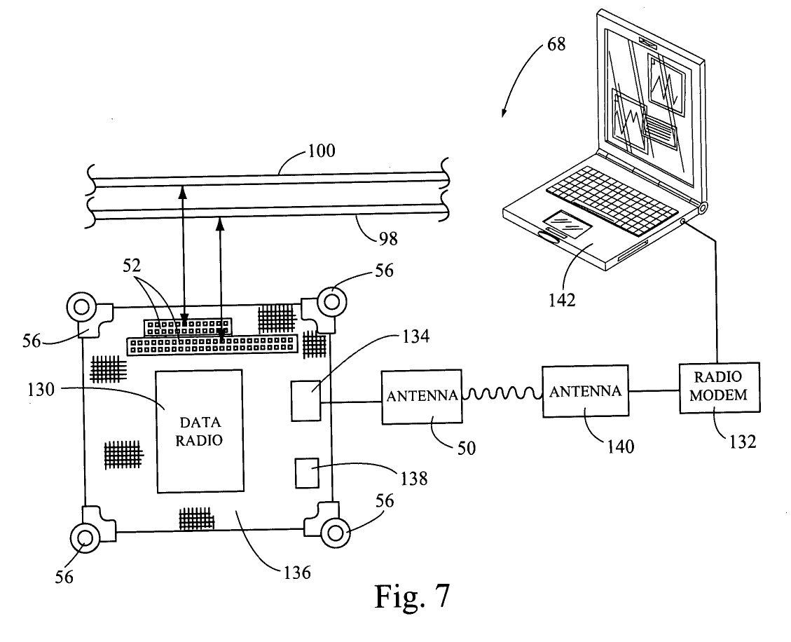

The communications subsystem 68 is graphically represented in FIG. 7. Typically, the communications subsystem comprises a wireless radio transmitter and receiver 130 that transmits and receives data using a RS-232 protocol to and from a radio modem 132 having an antenna 140 and operating using the same protocol. An antenna port 134 on the circuit board 136 is provided to which the aforementioned antenna 50 can be attached with or without an associated cable depending on whether the stack 18 is contained within the housing 14. A power port connector 138 is also provided on the board wherein the board can be connected to a regulated power supply, so that the subsystem can be tested and configured without having to integrate it with the stack and the power subsystem 60. Finally, the communications subsystem includes a bus connector 52 to operatively couple the subsystem to the stack. The subsystem operates on unswitched 5 VDC as received from pin 3 of row B of the connector (see FIG. 10). Further, data is sent through the RF serial pins, specifically pins 26 and 27 of row A and pins 13 and 14 of row B.

One radio 130 used in certain embodiments and variations comprises a 900 MHz 9600 bit per second OEM radio unit by MaxStream, Inc. of Orem, Utah. The radio uses frequency hopping in the 900 MHz ISM band to communicate with the XStream-PKG radio modem 132. The radios can be configured to operate on anyone of a number of channels such that multiple educational satellite systems 10 can be operated in a single laboratory simultaneously without interfering with each other.

The radio modem 132 is typically connected to a personal computer (PC) 142 using its serial port. The form of the data is identical to that sent and obtained when the PC is directly connected to the central data handling subsystem 66 via the general umbilical RS-232 124 via a serial cable. The telemetry data is viewed on the PC using any one of many commonly available terminal emulators and commands that are compliant with the firmware programming of the central data handling subsystem 66 are entered into the PC for transmission using the terminal emulator. In other variations, a graphical user interface is used in place of a terminal emulator.

The Attitude Control Subsystem

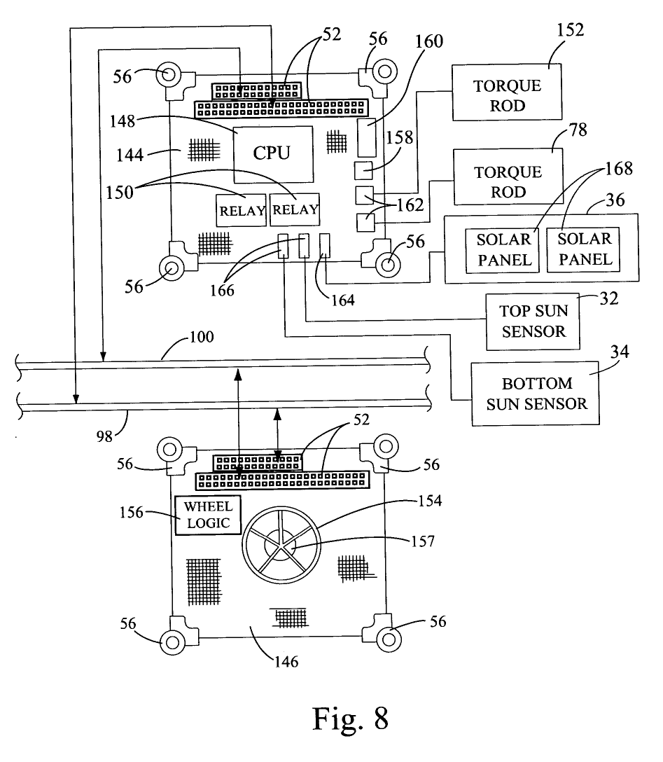

The attitude control subsystem 70 is graphically represented in FIG. 8 and in its full functionality configuration comprises two circuit boards 144 & 146 although in variations only a single board is required to obtain most of the satellite's functionality. The first board 144 (referred to herein as the attitude controller board) comprises a CPU 148, various relays 150, and a plurality of connectors for coupling with a number of sensors and torque rod attitude control devices 152. The attitude controller board 144 also includes a bus connector 52 through which it receives commands and transmits telemetry to the central data handling subsystem 66 and from which it receives both switched regulated 5 VDC for operating the CPU and other logic chips and unregulated 9 VDC for powering the torque rods 152.

The optional second circuit board 146 (referred to herein as the wheel board) of the attitude control subsystem 70 comprises a reaction wheel 154 and associated electronics 156 to control the speed and rotational direction of the wheel. The wheel board 146 is coupled to the power bus 98 via pin 8 of row B, which provides 3.3 volt switched power to the reaction wheel's motor 157, and pin 2 of row A, which provides 5 Vdc switched current to the electronics of the wheel board. The wheel board is also coupled to the data bus 100 through a number of pins as specifically indicated in FIG. 10 for communicating with both the attitude controller board 144 and the central data handling subsystem 66. In another contemplated embodiment the electronics for controlling the wheel board reside on the attitude controller board.

Referring back to the attitude controller board 144, a power port 158 is provided for powering up the CPU 148 and associated logic of the board without having to integrate the board into the stack 18 for testing and verification purposes. Further, an RS-232 connector 160 is provided to allow a user to send commands to and receive telemetry directly from the CPU when the board is not integrated. Additionally, two 9v connectors 162 are provided to which the torque rods 152 can be coupled. The directional flow of current through these connectors can be reversed by activating associated relays 150 to selectively reverse the polarity of the torque rods. Finally, connectors 164 & 166 are provided for connecting various sensors to the attitude controller board, namely the yaw sensors 36 and top and bottom sun sensors 32 & 34 mentioned above.

Operationally, the attitude control subsystem 70 is adapted to (i) determine the positioning of the satellite about the generally vertical center axis of the satellite as defined by the satellite's pivotal connection at the housing eyelet 20 and (ii) control the attitude positioning of the satellite. Accordingly, the mechanisms relating to attitude adjustment of orbiting satellites can be taught and explained. Actual flight satellites have the capability of determining, controlling and adjusting their attitude about more than a single degree of freedom as they incorporate additional sensors and attitude control devices. Hampered by the constraints imposed by gravity and given a desire to reduce the complexity of the educational satellite to facilitate teaching, the illustrated embodiment is limited to a single degree of rotational freedom along the center axis. It is to be appreciated that variations and alternative embodiments are contemplated that incorporate additional sensors and control devices to impart full attitude determination and control to the satellite about multiple degrees of freedom.

The yaw sensors 36 comprise two small solar panels 168 situated next to each but orientated orthogonally relative to each other. Based on the current developed in each panel and the differences therebetween, the positioning of the satellite can be determined relative to a fixed light source (representative of the sun for instance) along a 180 degree arc.

The top and bottom sun sensors 32 & 34 each comprise photo resistors whose resistance varies relative to the light incident on them. The particular sensors used in one embodiment comprise Cadmium Sulfide type sensors that are set down within a black non-reflective well housing such that they only measure light incident on the sensors over a relatively narrow range incident to the sensors. Based on readings reported as telemetry, a student can determine whether the fixed light source is above or below the satellite.

To control the satellite, two different types of control devices are provided: torque rods 152 and the reaction wheel 154 of the wheel board 146. Each of the two torque rods illustrated in relation to the one embodiment comprise highly polar electromagnets that have their axis arranged orthogonally to each other generally in planes that are perpendicular to the generally vertical axis as best shown in FIG. 1. In orbiting satellites, the polarity of the torque rods, as well as, which torque rod is activated varies the effect the Earth's magnetic pole has on the satellite and causes the satellite to rotate and change its attitude appropriately. To simulate the Earth's magnetic poles a high powered torque rod (not shown) powered by an external power supply, or a powerful permanent magnet, is located in general proximity to the suspended satellite embodiment. By selectively switching the polarities of the provided orthogonally aligned torque rods, the satellite can be made to pivot about the central axis. As can be appreciated, torque rods require relatively large amounts of power when compared to reaction wheels. Further, controlling a satellite with extreme precision using torque rods, although possible, is more difficult than using reaction wheels.

Reaction wheels take advantage of Newton's law that every action has an equal and opposite reaction. By varying the speed and rotational momentum of the reaction wheel, which has an axis of rotation essentially the same as the center axis, above or below its equilibrium speed and momentum, the remainder of the satellite will rotate in response, thereby changing the attitude of the satellite. Once the desired new attitude is reached the wheel is returned to its equilibrium rotational speed to stabilize the satellite in its new position. The wheel board includes logic in associated electronics 156 for precisely controlling the speed of the wheel motor 157 as well as measuring the wheel's rate of rotation. The rate of spin is responsive to control via commands from the controller board 144 as received over the data bus 100 from the central data handling subsystem 66. In orbital use, the equilibrium speed of the wheel does not remain fixed as the speed of the wheel must be gradually increased or decreased to account for external forces, such as atmospheric drag, acting on the satellite. The ability to control the satellite by way of the reaction wheel alone is lost once the equilibrium speed of the wheel has increased to the maximum or minimum operational speed of the wheel and its associated motor. To restore functionality to the reaction wheel, some of the wheel's momentum must be dumped. Momentum can be dumped using the torque rods by applying an opposite external torque to the satellite permitting the speed of the wheel to be slowed or increased to its operating range.

In use with embodiments of the educational satellite described herein, the operation of the torque rods 152 and reaction wheel 154 are manually controlled by the student who enters in commands relating to the operation of the control devices, such as turning the torque rods off and on, the speed of the reaction wheel, the polarity of the torque rods. The student can visually gauge the satellite positioning but for a more realistic simulation he/she can use the telemetry from the yaw and suns sensors alone to determine the attitude of the satellite. In variations and alternative embodiments, the CPU 148 of the attitude control subsystem 70 can be configured through firmware or software to automatically control the attitude of the satellite by periodically sampling the sensors and making necessary adjustments with the reaction wheel and/or torque rods. An automatic momentum dump mode can be provided as well, wherein the reaction wheel's momentum is automatically scrubbed when it reaches a certain speed.

A Method of Teaching Satellite Engineering

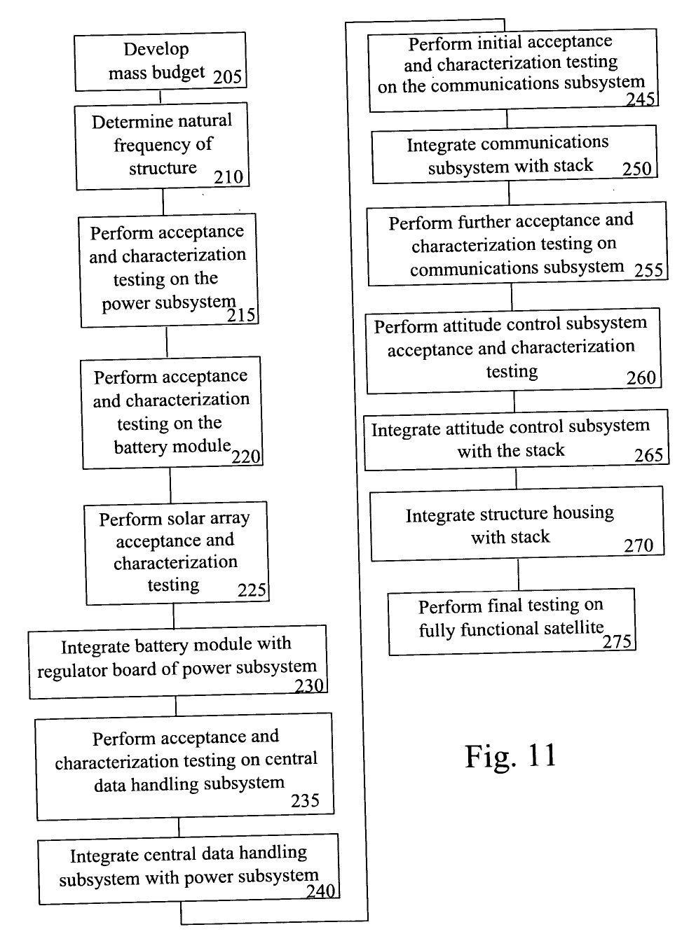

As described and discussed above various embodiments of the educational satellite can be used to facilitate the teaching of satellite engineering and operation. FIG. 11 is a flow chart illustrating the operations that are performed in one type of laboratory class using an embodiment of an educational satellite. The students taking this laboratory course act as satellite integrators who build, test and characterize a satellite using various modular subsystems as described and discussed in detail above. The course culminates in a complete fully functional educational satellite with which the students can receive telemetry and direct the operation thereof from a personal computer base station. The laboratory course can be combined with a text book course teaching the fundamentals of satellite design and operation. Appendices A and B include a lab manual and student workbook for an exemplary laboratory course.

As indicated in block 205, the students develop a target mass budget for their satellite that relates to each of the specific subsystems, the satellite housing 14, and any peripherals that are to be included with the finished satellite. During the building and integration of the satellite as the course progresses, the students weigh the various subsystems and other components and verify compliance with the mass budget. Next, as indicated in block 210, the students determine the natural frequency of the satellite using a mass-spring model of the educational satellite.

Acceptance and characterization testing (hereafter AC testing) is then performed on the power subsystem 60 as indicated in block 215. The acceptance testing typically includes a visual inspection of the components and comparison with a standard (such as photographs and pictures of a previously accepted power subsystem). The acceptance testing also typically includes connecting a personal computer 142 running a suitable terminal program to the regulator board 60 (if the above described embodiment is being utilized) via the provided RS-232 port 104. The board should output telemetry information to the personal computer. The output of the various switched and unswitched 3.3v and 5.0v power outputs generated by the board's power supplies are verified and characterized under a number of different loading scenarios. Any differences between the telemetry output concerning voltage and current reading as compared to direct readings taken by a multimeter are noted. Optionally, the CPU 102 of the power subsystem may be re-programmed as necessary to calibrate the outputs with the actual readings. It is appreciated that the board can be powered by the battery board 62 or, more commonly, a separate regulated 10v power supply coupled to the board by way of the input connector 82 for the AC testing.

AC testing of the power subsystem also includes specific AC testing of the battery board 62 and the associated solar panels 30 as indicated in blocks 220 & 225. Testing of the battery board typically includes a visual inspection and verification that (i) power is being transmitted through the proper pins on the bus connector 52, (ii) the battery pack 88 can take and hold a charge, and (iii) the current draw from the battery pack is acceptable. Testing of the solar panels typically include (i) a visual inspection, (ii) operational verification, and (iii) characterization testing involving determining power output under different lighting and loading scenarios.

Once the power subsystem has been determined to be acceptable, the regulator and battery boards 62 & 64 are integrated with each other as indicated in block 230. Additional testing can be performed to ensure that the two units are functioning properly as integrated.

In another lab class or classes, AC testing is performed on the central data handling subsystem 66 as indicated in block 235. Initially, the subsystem module is visually inspected against a known standard. Next, the personal computer 142 running the terminal program is connected to the subsystem via the provided RS-232 umbilical connector 124. The telemetry is observed and verified. Additionally, several commands are sent to the subsystem and compliance with the commands is verified via subsequent telemetry. Once, the AC testing has been completed the control and data handling subsystem module is integrated onto the power subsystem by aligning the snap stick connectors 56 and the pins 54 on the bottom of the control and data handling subsystem board with the associated connectors 56 and pin openings on the bus connector 52 as indicated in block 240.

Referring to block 245, AC testing is performed on the communication subsystem 68. First, the subsystem module is visually inspected against a known standard. Next, a functional test of the subsystem is performed by (i) powering up the data radio 130 with a power supply via the appropriate pin openings in the associated bus connector 52, (ii) connecting the associated radio modem 132 to the personal computer 142, (iii) running a loopback test routine as provided by the manufacturer of the data radio and the radio modem, and (iv) recording the number of “good” and “bad” packets sent during the test. Assuming the ratio of good to bad packets is acceptable, the communications subsystem is integrated on top of the control and data handling subsystem of the satellite stack by aligning the appropriate pins and connectors as indicated in block 250.

Once the communications subsystem has been integrated onto the stack, additional AC testing is typically performed as indicated in block 255. Particularly, the RS-232 cable of the personal computer running the terminal program is connected to the RF connector 126 on the control and data handling subsystem board. Commands and telemetry are transmitted and received by the students via this link, which emulate radio communications through the data radio. Essentially, all commands sent when connected to the RF connector are first sent through the data radio before being routed to the CPU of the control and data handling subsystem. This is in contrast to connecting the computer to stack by way of the umbilical connector 124, wherein telemetry and commands are sent directly between the computer and the control and data handling CPU. Provided emulated communications are trouble free, the RS-232 cable is disconnected from both the RF connector and the computer, and the radio modem is connected to the computer via a serial connection. At this point, the student can communicate with the satellite wirelessly by way of the communications subsystem.

Next, AC testing is performed on the attitude control subsystem 70 as shown in block 260. Like the other subsystems, the attitude control subsystem, including both the wheel board 146 and the controller board 144, is visually inspected relative to a known standard. Further, the torque rods 78, yaw sensors 36 and sun sensors 32 & 34 are visually inspected. The torque rods are powered up using a power supply and their functionality is verified using a compass. The sun sensors' functionality is verified by attaching them to a multimeter and recording the sensors' levels of resistance at different amounts of illumination. The yaw sensors' functionality is verified by measuring the voltages produced by the sensors in different lighting conditions.

After the functionality of the torque rods and sensors have been verified, the functionality of the controller board is verified before integrating it with the stack. A power supply is connected to the power port 158, and a RS-232 cable of a personal computer 144 running the terminal program is connected to the provided RS-232 connector 160. Further the sensors and the torque rods are connected to the controller board 144 via the respective connectors 162, 164 & 166. Telemetry from the sensors and torque rods are verified. The sensors are subject to differing lighting conditions and the results from the associated telemetry are recorded. Commands are sent from the computer to the controller board to turn the torque rods off and on, as well as, change their polarity.

During the attitude control subsystem's AC testing, the wheel board 146 on which the reaction wheel 154 resides is also visually inspected and functionally tested to verify its proper operation. Provided the controller board 144 and the wheel board 146 are both found to be operating properly, they are integrated into the stack 18 by coupling them to each other and the stack using the mechanical Snapstick™ connectors 56, as well as, the bus connector 52 and corresponding pins 54 as indicated in block 265. The sensors and torque rods are also coupled via the appropriate connectors to the controller board. Once integration is complete, telemetry from the central data handling subsystem 66 is observed to verify that telemetry from the attitude control subsystem is being received through the central data handling subsystem. Various commands similar to the one used above when the attitude control subsystem 70 was tested prior to integration are transmitted through the central data handling subsystem preferably by way of the communications subsystem to verify the attitude control subsystem can be controlled remotely as an integrated module.

After the stack 18 has been completed, the stack is integrated or placed in its structural housing as indicated in block 270. Additionally a number of thermal sensors (thermistors) are coupled to the stack via connectors on the central data handling subsystem 66 including the thermistors associated with the black and white thermal panels 40 & 38. The fully integrated educational satellite is then suspended typically from a location corresponding to a center axis of the satellite. An appropriately positioned eyelet 20 is provided on the structural housing 14 of one embodiment. As illustrated herein, the satellite can be suspended from a suitable stand but in variations the satellite can also be suspended from a ceiling or any other appropriate structure that permits the satellite to rotate freely.

The culmination of the course occurs when the students run the satellite through a fully functional test scenario as indicated in block 275. The testing includes issuing commands to the unit and observing and recording telemetry related to the outcome of the commands. Thermal characteristics of the satellite can be examined by shining a halogen lamp on various sides of the unit and recording the effect this has on the satellite's temperature. In certain embodiments, the satellite includes a closed-loop mode in which the attitude control subsystem 70 is programmed to pivot towards a light source as the light source moves.

Other Embodiments and Other Variations

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

Variations of the satellite can be fabricated with flight qualified hardware and components such that, if desired, it could launched into orbit. Of course, flight capable variations may have additional torque rods and or reactions wheels than illustrated herein such that the satellite could be pivoted about three orthogonal axes. Flight capable satellite variations would still include one or both of common mechanical and bus connectors. In other variations and embodiments of the satellite, the configuration of the satellite and the various subsystems can vary substantially. For example, different types of mechanical connectors can be used; different types of bus connectors can be used; the bus pin assignments can vary; and the size and shape of the circuit boards can vary. In yet other variations and embodiments, one or more additional subsystems can be provided, or one or more of the subsystems described above can be omitted. For example, in one variation, the satellite stack can be operated sans the structural housing by hanging the stack from fittings secured to the Snapstick™ connectors.

The method of teaching satellite engineering described above is merely exemplary and is not intended to limit the scope of the present invention to any one methodology. Rather, broad educational uses of the satellite system are contemplated. For example, the satellite can be used as a platform for new subsystems that are designed as part of an advanced engineering class. Further, the satellite can be used in other courses that pertain primarily to the control and operation of satellites without going through all the AC testing of the above described course. Simply, the flexible modular configuration of embodiments of the educational satellite system make it suitable for use in a wide range of educational activities from introductory courses concerning satellite operation wherein an instructor uses the satellite to demonstrate various operational principles to advanced courses wherein students actually build compatible subsystems and/or develop specific programming routines relating to the operation of the satellite.

We claim:

1. An educational satellite system comprising:
a central data handling subsystem module adapted to receive and send data and command signals, the central data handling subsystem module having a first bus connector;
a communications subsystem module adapted to receive commands and transmit telemetry, the communications subsystem module having a second bus connector;
an attitude control subsystem module adapted to determine the orientation of educational satellite system, the attitude control subsystem module having a third bus connector; and
a power subsystem module adapted to supply power to educational satellite system, the power subsystem module have a fourth bus connector;
wherein the first, second, third, and fourth bus connectors share a common configuration and are situated on the central data handling subsystem module, the communications subsystem module, the attitude control subsystem module, and the power subsystem module respectively to facilitate the operative coupling of the modules.

2. The educational satellite of claim 1, wherein at least one of the central data handling subsystem module, the communications subsystem module, the attitude control subsystem module, and the power subsystem module is non-flight capable.

3. The educational satellite system of claim 1, wherein each of the central data handling subsystem module, the communications subsystem module, the attitude control subsystem module, and the power subsystem module comprises at least one circuit board distinct from the circuit boards of the other modules.

4. The educational satellite system of claim 1, wherein each of the central data handling subsystem module, the communications subsystem module, the attitude control subsystem module, and the power subsystem module further comprises at least one mechanical connector, the mechanical connectors being adapted to couple to each other.

5. The educational satellite system of claim 4, wherein the mechanical connectors comprise snap-together connectors.

6. The educational satellite of claim 1, further comprising a housing, the housing being adapted to at least partially contain and support the central data handling, communications subsystem, attitude control subsystem, and power subsystem modules therein.

7. The educational satellite of claim 6, wherein the housing is translucent.

8. The educational satellite of claim 1, wherein the communications module includes a wireless transceiver.

9. The educational satellite of claim 1, wherein the attitude control subsystem module is further adapted to control the attitude positioning of the educational satellite about at least one axis.

10. The educational satellite of claim 9, wherein the attitude control subsystem module further comprises one or more torque rods.

11. The educational satellite of claim 9, wherein the attitude control subsystem module further comprises at least one reaction wheel.

12. The educational satellite of claim 3, wherein the power subsystem module further comprises a battery pack located on a second circuit board.

13. The educational satellite of claim 1, wherein the bus connectors comprise a PC/104 bus configuration.

14. The educational satellite of claim 1, wherein the power subsystem module further comprises one or more solar panels.

15. The educational satellite of claim 1, wherein the attitude control subsystem module further comprises at least one of the group including attitude sensors and sun sensors.

16. The educational satellite of claim 1, further comprising a hanger, the hanger being located on the top of the satellite coincident with a pivotal axis of the satellite.

17. The educational satellite of claim 1, wherein the communications subsystem module is adapted for wireless communication with a personal computer equipped with a wireless modem.

18. An educational satellite comprising two or more functional subsystems, at least one of the two or more functional subsystems being physically separable from the at least one other functional subsystem of the two or more functional subsystems, the separate functional subsystems being adapted to couple to each other by way of a standard bus through compatible bus connectors on each separate functional subsystem, at least one separate subsystem being non-flight capable.

19. The educational satellite of claim 18, wherein the two or more functional subsystems include at least two of the group comprising: (a) a power subsystem; (b) a central data handling subsystem; (c) a communications subsystem; and (d) an attitude control subsystem.

20. The educational satellite of claim 18, wherein the separate functional subsystems are further adapted to be coupled using compatible mechanical connectors.

21. The educational satellite of claim 18, wherein each separate functional subsystem is capable of operation independent of the other separate functional subsystems when a suitable power source is provided.

22. The educational satellite of claim 19, wherein the power subsystem, the central data handling subsystem module, and the attitude control subsystem each have a data interface connector for directly coupling with a personal computer through a suitable cable.

23. The educational satellite of claim 18, wherein each circuit board of each separate functional subsystem module is the substantially same size and configuration as each other circuit board of each other separate functional subsystem module.

24. The educational satellite of claim 18, wherein the standard bus includes both a power and a data bus.

25. A method comprising:
providing one or more non-flight capable satellites, each satellite comprising two or more functional subsystems, at least one of the two or more functional subsystems being physically separable from the at least one other functional subsystem of the two or more functional subsystems, the separate functional subsystems being adapted to couple to each other by way of a standard bus; and
using the satellite in conjunction with instruction to one or more students concerning at least one of the group of (i) satellite design, (ii) satellite engineering, (iii) satellite operation, (iv) satellite fabrication, and (v) satellite testing.

26. The method of claim 25, wherein the two or more functional subsystems include at least two of the group comprising: (a) a power subsystem; (b) a central data handling subsystem; (c) a communications subsystem; and (d) an attitude control subsystem.

27. The method of claim 25, wherein the separate functional subsystems are adapted to be coupled using compatible mechanical connectors.

28. The method of claim 25, wherein said using the satellite in conjunction with instruction further comprises: (1) performing functionality testing on each separate functional subsystem prior to integration with the other functional subsystems; and (2) performing functionality testing on the satellite when the two or more functional systems are integrated together.

29. A method of building a satellite comprising:
providing a modular satellite kit, the satellite kit including a plurality of prefabricated modules, each module utilizing a common bus standard and including (i) standard bus connectors compatible with bus connectors of each other module, (ii) standard mechanical connectors adapted to couple the module with each other module;
testing each module to verify the functionality of the module prior to integration of the module with the other modules of the plurality of modules;
coupling each module with the other modules of the plurality of modules by way of the standard mechanical connectors and the standard bus connectors; and
testing the integrated satellite kit to verify functionality thereof.

30. The method of claim 29, wherein said testing each module to verify functionality of the module further comprises calibrating one or more parameters of at least one module.

31. The method of claim 29, wherein said testing each module to verify functionality of the module further comprising reading telemetry directly from the module by coupling the module with a personal computer

32. The method of claim 29, wherein said testing the integrated satellite kit to verify functionality further comprises sending commands and receiving telemetry to and from the integrated satellite wirelessly using a personal computer having a wireless transceiver.

33. The method of claim 29, further comprising installing the integrated satellite kit in a structural housing.

34. The method of claim 29, further comprising designing and fabricating a new module using the common bus standard and including the standard bus and mechanical connectors.
